(19) United States
(12) Patent Application Publication
(10) Pub. No.: US 2021/0135930 A1
(43) Pub. Date: May 6, 2021

(54) MANAGEMENT OF DATA TRANSPORT NETWORKS

(71) Applicant: ARIA NETWORKS LIMITED, Bath (GB)

(72) Inventors: Jay PERRETT, Calne Wiltshire (GB); Arthur Athelstan WADE, Chippenham Essex (GB); Stephen Jeffery NEWTON, Essex (GB)

(21) Appl. No.: 16/079,011

(22) PCT Filed: Feb. 22, 2017
(86) PCT No.: PCT/GB2017/050457

§ 371 Date: Aug. 22, 2018

(30) Foreign Application Priority Data
Feb. 22, 2016 (GB) 1603041.3

(51) Int. Cl. H04L 12/24

(52) U.S. Cl. CPC H04L 41/082; H04L 41/145; H04L 41/0823

(57) ABSTRACT

The invention provides a device for processing a subset of network orchestration computations to support management of network functions within a service chain spanning multiple domains of a data transport network. The device comprises receiving logic arranged to receive computation inputs expressed in terms of a data model for describing the data transport network; processing logic arranged to process the computation inputs; and outputting logic arranged to output an output of the processing logic, the output expressed in terms of the data model.

### FIELD OF THE INVENTION

This invention relates to the management of data transport networks. In particular, the invention relates to managing available network resources for accommodating changing data traffic demands on a data transport network such as or comprising a telecommunications network. Such management of available network resources may be referred to as network orchestration, and may include management, or orchestration, of software defined networks (SDNs) and virtual network functions (VNFs) to improve real time efficiency of multilayer data transport networks.

### BACKGROUND

VNFs, such as virtual fire walls (VFWs) or application delivery controllers (ADCs), may be strung together by an orchestrator or VNF manager into a service chain that supports a service. For example, an email service chain could include VNFs for virus scanning, span filtering and phishing detection routed through low latency connections. Internet traffic, on the other hand, would be routed through a service chain that includes virus scanning and an ADC. A service chain created for high quality interactive traffic, such as gaming or voice application, could include a VNF for traffic shaping so that traffic would be routed over links with a level of delay and jitter guarantees purchased by each customer. Each type of service chain includes the VNFs it needs, and can exclude the unnecessary ones. In this way, SDNs and VNFs can make service chain and application provisioning programmable in both pure SDNs and hybrid virtual and physical networks.

Real time creation, adaptation and removal of SDNs and VNFs to provision service chains is implemented by orchestrators which comprise large proprietary applications, each for managing a proprietary subset, sometimes referred to as a domain, of a network. The applications may be supported by on chip support for managing certain VNFs. In order to provide network-wide traffic management across multiple domains, different orchestrators have to communicate with each other.

It is an object of the invention to improve present technologies for managing data transport networks.

### SUMMARY OF THE INVENTION

A first aspect of the invention provides a device for processing a subset of network orchestration computations to support management of network functions within a service chain spanning multiple domains of a data transport network, the device comprising: receiving logic arranged to receive computation inputs expressed in terms of a data model for describing the data transport network; processing logic arranged to process the computation inputs; and outputting logic arranged to output an output of the processing logic, the output expressed in terms of the data model.

At least one of the receiving logic and the outputting logic may be arranged to exchange data expressed in terms of the data model with an external data store that stores a shared description of the data transport network expressed in terms of the data model.

At least part of the processing logic may comprise model adaptation logic arranged to convert an input description of a state of at least part of the data transport network into an abstracted description of the state of at least part of the data transport network expressed in terms of the data model.

The model adaptation logic may be arranged to output the abstracted description to the external data store to update the shared description stored at the external data store.

At least part of the processing logic may comprise current state logic arranged to determine whether a network update is pending, and cause a copy of at least part of the shared description to be output by the outputting logic either immediately if there is no network update pending or after a pending network update is completed if there is a network update pending.

The current state logic may determine whether a network update is pending by monitoring signals from the model adaptation logic.

The current state logic may be arranged to determine whether a data analysis update is pending, and cause a copy of at least part of the shared description to be output by the outputting logic either immediately if there is no data analysis update pending or after a pending data analysis update is completed if there is a data analysis update pending.

The current state logic may determine whether a data analysis update is pending by monitoring signals from an external data analysis module.

At least part of the processing logic may comprise evolution logic arranged to evolve candidate solutions expressed in terms of the data model towards an optimum solution using a genetic algorithm and to determine an optimised output solution expressed in terms of the data model.

At least part of the processing logic may comprise objective function logic arranged to support the use of the genetic algorithm by causing computation of a value of a fitness function of each of the candidate solutions.

Causing computation of a value of a fitness function of each of the candidate solutions may comprise: the objective function logic computing the values of the fitness function; causing external software to compute the values of the fitness function; causing a photonic quantum processor to compute the values of the fitness function; or as default behaviour, the objective function logic computing the values of the fitness function, but, if instructed, the objective function logic causing external software or a photonic quantum processor to compute the values of the fitness function.

The device may comprise a processor. The receiving logic, the processing logic and the outputting logic may comprise hardware logic. The device may be implemented as at least one semiconductor chip. The data transport network may comprise a telecommunications network.

The invention also extends to code that when executed on a processor of a system causes the system to generate the device in hardware.

A second aspect of the invention provides a photonic quantum processor for processing a subset of network orchestration computations to support management of network functions within a service chain spanning multiple domains of a data transport network, the device comprising: receiving logic arranged to receive computation inputs expressed in terms of a data model for describing the data transport network; processing logic arranged to process the computation inputs; and outputting logic arranged to output an output of the processing logic, the output expressed in terms of the data model.

At least part of the processing logic may comprise evolution logic arranged to evolve candidate solutions expressed in terms of the data model towards an optimum solution using a genetic algorithm and to determine an optimised output solution expressed in terms of the data model.

At least part of the processing logic comprises objective function logic arranged to support the use of the genetic algorithm by computing a value of a fitness function of each of the candidate solutions.

At least part of the processing logic comprises objective function logic arranged to support the use of a genetic algorithm for evolving candidate solutions expressed in terms of the data model by computing a value of a fitness function of each of the candidate solutions.

The data transport network may comprise a telecommunications network.

The invention extends to a system for processing a subset of network orchestration computations to support coordination of network functions across a data transport network, the system comprising: the device defined above; and a photonic quantum processor for performing one or more predetermined processing tasks.

The one or more predetermined processing tasks may comprise evolving candidate solutions expressed in terms of the data model towards an optimum solution using a genetic algorithm and to determining an output solution expressed in terms of the data model.

The one or more predetermined processing tasks may comprise computing a value of a fitness function of each of the candidate solutions.

### DESCRIPTION OF THE DRAWINGS

The invention will now be described by way of example with reference to the following drawings, of which:

FIG. 1 is a schematic block diagram of a device according to an embodiment of the invention;

FIG. 2 is a flow chart of a method of maintaining a shared description of a data transport network;

FIG. 3 is a flow chart of a method of determining an optimised solution for configuring a data transport network;

FIG. 4 is a flow chart of determining an optimised solution;

FIG. 5 is a flow chart of evolving a set of candidate solutions towards an optimised solution;

FIG. 6 is a schematic block diagram of photonic quantum processor according to a further embodiment of the invention; and

FIG. 7 is a schematic block diagram of another photonic quantum processor according to the further embodiment of the invention.

Like reference numerals refer to like features or elements throughout the drawings.

### DETAILED DESCRIPTION OF THE INVENTION

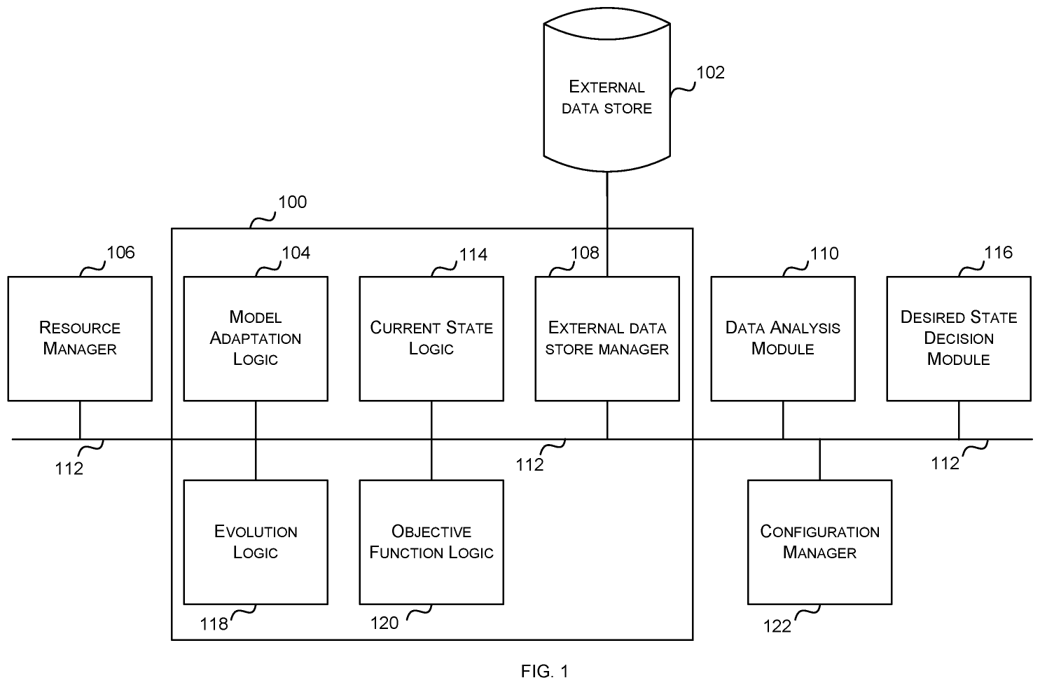

Referring to FIG. 1, an embodiment of the invention provides a device 100 for processing a subset of network orchestration computations to support management of network functions within a service chain spanning multiple domains of a data transport network. The device 100, which may be implemented as a semiconductor chip, comprises receiving logic arranged to receive computation inputs expressed in terms of a data model for describing the data transport network; processing logic arranged to process the computation inputs; and outputting logic arranged to output an output of the processing logic, the output expressed in terms of the data model. The receiving logic and the outputting logic enable the device to interface with other devices, and the processing logic enables the device to perform computations. The data model for describing the data transport network is suitable for describing the whole of the data transport network, even if it comprises different proprietary domains. Thus, the data model can be used to express an instantiated model of a real data transport network, even if the real network comprises different proprietary domains that would normally be described differently by respective orchestrators comprising proprietary applications. It will be appreciated that the device is for processing a subset of network orchestration computations in the sense that some of the network orchestration computations will be performed off the device. For example, data analysis computations may be performed off the device in software applications, as described further below. Thus, the network orchestration computations are a whole are performed by a collaboration between the device 100 and the software applications.

The receiving logic and/or the outputting logic may be arranged to exchange data expressed in terms of the data model with an external data store 102 that stores a shared description of the data transport network expressed in terms of the data model. The shared description is accessible by the device and other similar devices, and may be referred to or updated by the device and by the other similar devices when performing computations.

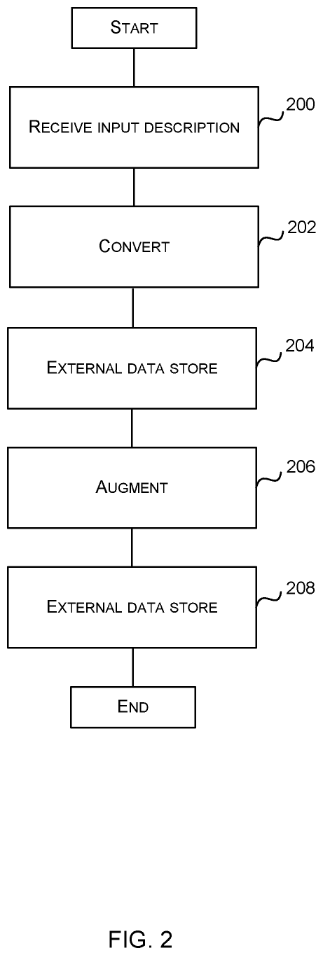

At least part of the processing logic of the device 100 may comprise model adaptation logic 104 arranged to convert an input description of a state of at least part of the data transport network into an abstracted description of the state of at least part of the data transport expressed in terms of the data model. The input description is not expressed in terms of the data model, but instead may be expressed in another format such as a proprietary format used by a network operator. Thus, referring additionally to FIG. 2, the model adaptation logic 104 receives 200 the input description and converts 202 it into a format that is expressed in terms of the data model. The input description comprises a description of the current state of at least part of the data transport network and is provided to the model adaptation logic 104 by a resource manager 106 of the data transport network.

The model adaptation logic 104 may be arranged to output the abstracted description to the external data store 102 to update 204 the shared description stored at the external data store. This enables current state information to flow from the resource manager 106 to the external data store 102, for example through an external data store manager 108, in an appropriate format.

A data analysis module 110 may augment 206 the abstracted description, for example by examining the service cost profile or the service latency profile of all routed services and adding computed data to the description. The resulting augmented description is converted into a format expressed in terms of the data model and sent to the device 100 to update 208 the shared description at the external data store 102. Since service profiles of parameters like cost and latency vary between network operators, their analysis cannot be standardised across the whole network and implemented on chip. As a result, the data analysis module 110 may suitably be implemented in software, exchanging data with the device 100 through a data bus 112.

It can be seen that the model adaptation logic 104, the external data store manager 108, and the data analysis module 110 collaborate to maintain the shared description at the external data store 102. When new information about the current state of the network is provided by the resource manager 106, it is converted by the model adaptation logic 104, augmented by the data analysis module 110, and output to the external data store 102.

At least part of the processing logic of the device 100 may comprise current state logic 114 for handling queries received by the device 100 for a current state of the network. The current state logic 114 is arranged to determine whether a network update is pending, and to cause a copy of at least part of the shared description to be output by the outputting logic either immediately if there is no network update pending or after a pending network update is completed if there is a network update pending. The current state logic 114 may, for example, determine whether a network update is pending by monitoring signals from the model adaptation logic 104 or by monitoring other traffic on the device 100. Alternatively, the query may instruct the current state logic 114 to cause a copy of at least part of the shared description to be output immediately even if there is a network update pending. A network update is pending if the model adaptation logic 104 is processing an input description received from the resource manager 106.

The current state logic 114 may also be arranged to determine whether a data analysis update is pending, and to cause a copy of at least part of the shared description to be output by the outputting logic either immediately if there is no data analysis update pending or after a pending data analysis update is completed if there is a data analysis update pending. The current state logic 114 may, for example, determine whether a network update is pending by monitoring signals from the data analysis module 110. Alternatively, the query may instruct the current state logic 114 to cause a copy of at least part of the shared description to be output immediately even if there is a data analysis update pending.

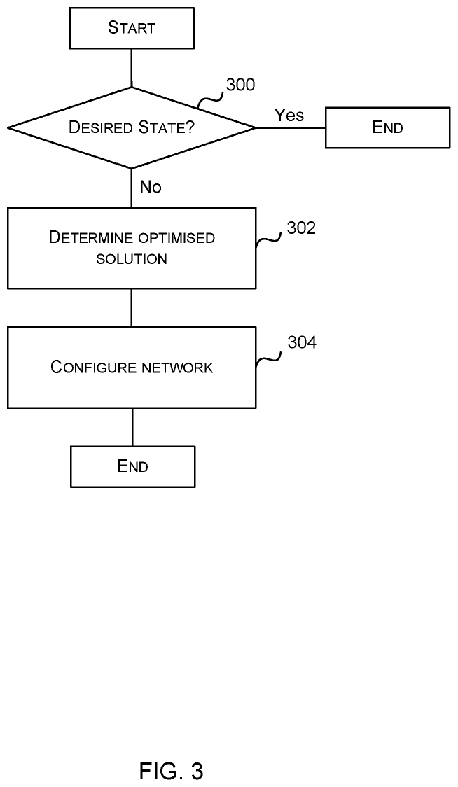

With additional reference to FIG. 3, a desired state decision module 116 may determine the current state of the network, for example by sending a query for the current network state to the current state logic 114, and decide 300 whether the network is in a desired state. Such a decision is likely to be based on considerations of a network operator and will therefore be likely to vary between network operators. As a result, the data analysis module is suitably implemented in software, communicating with the device 100 through the data bus 112. If the result is that the network is determined to be in a desired state, the process ends and no action is required. If, however, the network is determined not to be in a desired state, the desired state decision module 116 invokes evolution logic 118 and objective function logic 120 of the device 100 to determine 302 an optimised solution for how to configure the network. Once an optimised solution has been determined, a configuration manager 122 of the network, which may be implemented in software, configures 304 the network to implement the optimised solution.

A process manager (not shown in the drawings) implemented in software may manage the above-described process. To this end, such a process manager may for example communicate with at least the model adaptation logic 104, the data analysis module 110 and the current state logic 114.

In further detail, at least part of the processing logic of the device 100 may comprise evolution logic arranged to evolve candidate solutions expressed in terms of the data model towards an optimum solution using a genetic algorithm and to determine an optimised output solution expressed in terms of the data model.

Furthermore, at least part of the processing logic may comprise objective function logic arranged to support the use of the genetic algorithm by causing computation of a value of a fitness function of each of the candidate solutions. For example, this may be achieved by the objective function logic itself computing the values of the fitness function, by the objective function logic causing external software to compute the values of the fitness function, or by causing a photonic quantum processor to compute the values of the fitness function. Alternatively, as default behaviour, the objective function logic may compute the values of the fitness function, but, if instructed, the objective function logic may cause external software or a photonic quantum processor to compute the values of the fitness function.

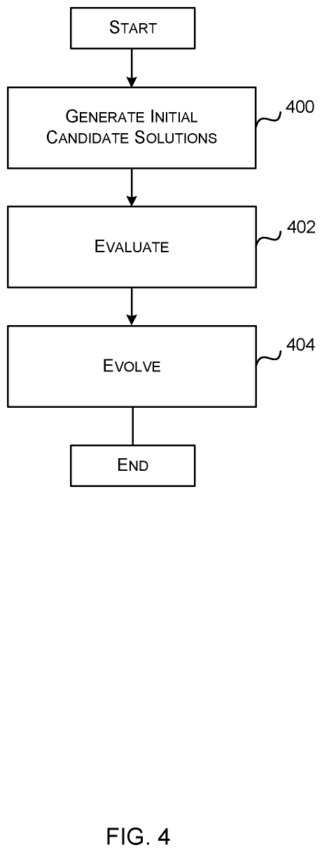

Referring to FIG. 4, the evolution process comprises an iterative process that starts with an initial set of candidate solutions for configuring the network and evolves the set of solutions towards an optimised solution. A set of candidate solutions for starting the process is generated at step 400. Each of the initial candidate solutions is evaluated 402 by computing a fitness function whose value indicates a suitability of the candidate solution. This enables the candidate solutions to be compared with each other, for example by ranking them in order of their fitness values, to establish which candidate solutions are strongest and which are weakest.

The initial set of candidate solutions, which may for example contain five hundred candidate solutions, is evolved at step 404 towards an optimum solution. This is achieved using an iterative approach that directs the development of the set of candidate solutions towards an optimum. In each iteration, the weakest candidate solutions—i.e. those with the lowest fitness function values—are replaced by newly generated candidate solutions, provided that the new candidate solutions have higher fitness functions than the weakest candidate solutions. This tends to increase the quality of the set of candidate solutions as the number of iterations increases, thereby evolving the set so that it becomes increasingly likely that the set includes the optimum solution for the network.

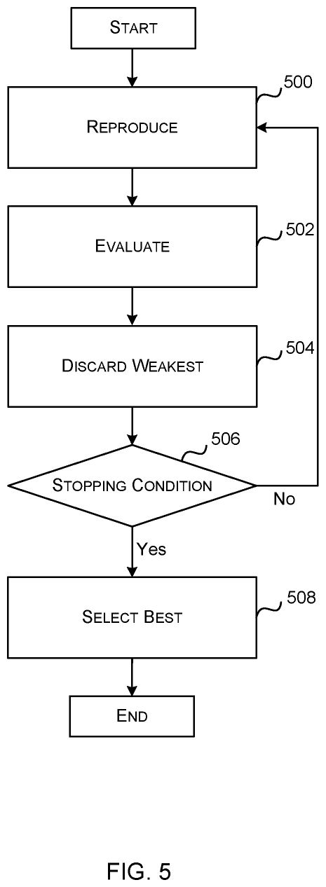

FIG. 5 shows the step of evolving 404 in more detail. The candidate solutions are reproduced 500 to produce one or more ‘child’ candidate solutions from the initial candidate solutions. The genetic algorithm comprises rules for reproducing the candidate solutions either by mating, mutating or a combination of both.

For example, a pair of child candidate solutions could be created by ‘mating’ two randomly selected parent candidate solutions. The mating process involves swapping corresponding portions of the parent candidate solutions to create two new child candidate solutions. For example, the routes provided by the parent candidate solutions between a particular source node and a particular destination node could be swapped. Alternatively, portions of routes could be swapped, or any other scrambling of the parent solutions could be carried out. Three or more candidate solutions could be scrambled to produce one or more child candidate solutions.

Another method of reproducing is to mutate a parent candidate solution. In this case, a parent candidate solution, which may be randomly selected from the gene pool of parent candidate solutions, is changed in a random, predetermined, or partially random manner. For example, every fifth node of each route could undergo a random change in functionality (e.g. from an optical cross connect to glass through). It will be appreciated that by mutating a single parent candidate solution, a single child candidate solution is created.

The creation of child candidate solutions increases the size of the gene pool of candidate solutions. For example, if the initial set of candidate solutions contains five hundred initial candidate solutions and two child candidate solutions are created, the enlarged gene pool contains five hundred and two candidate solutions. The child candidate solutions are evaluated 502 by calculating a fitness function of the type described above. The candidate solutions of the enlarged gene pool are now ranked in order of the value of their fitness function, and if n child candidate solutions were created in the reproducing step 500, the weakest n of the enlarged gene pool are discarded 504. Following the example above of five hundred initial candidate solutions and two child candidate solutions, the five hundred and two candidate solutions of the enlarged gene pool are ranked by fitness function value and the weakest two of the enlarged set are discarded. Thus, the total size of the gene pool remains constant over time but the quality of the population improves with cycles of the iteration. At worst, an iteration may produce child candidate solutions that are no better than any of the existing candidate solutions. In that case, the new child candidate solutions will be discarded immediately and the quality of the population, which may for example be expressed as a mean fitness function value, will be unchanged. In any other case an iteration will improve the quality of the population thereby increasing the likelihood that the gene pool contains the optimum routing solution.

The evolution process cycles through iterations by reproducing 500, evaluating 502, and discarding 504 the weakest candidate solutions to maintain a constant population size with each cycle and gradually increase the quality of the population. The gene pool may be said to evolve towards an optimum solution as a result of the bias towards better performing solutions introduced by discarding the weakest candidate solutions in each cycle.

The evolution is stopped when a sufficient number of iterations have been applied to reach a predetermined stopping condition 506. For example, two suitable stopping conditions are based on reaching a solution sufficiently close to the optimum solution and reaching a gene pool that is likely to contain the optimum solution.

In the first approach, a fitness function or a performance parameter such as cost of the optimum solution is estimated, and the best candidate solution in the gene pool is compared to the optimum to determine how close the best candidate solution to date is to the optimum solution. If the fitness function or performance parameter of the best candidate solution to date is sufficiently close to that of the optimum value, the stopping condition is satisfied and the evolution is stopped.

For example, if the only performance parameter is cost, the cost of the best solution to date will go down with each iteration, gradually approaching an asymptote which represents the cost of the optimum solution. At some point the cost of the best solution to date will have reached a value within a predetermined percentage, such as 5%, of the optimum cost, at which point the stopping condition is satisfied. After each round of evolution an asymptote is determined. This becomes more reliable with every round of evolution as it is based on more and more data, and can generally be calculated in a meaningful way from, for example, the tenth round onwards. In order to determine an asymptote, the cost improvement as a function of the number of iterations is approximated as a ratio of two polynomials of the same order. Such a rational function, R, may be expressed as follows.

$$R = \frac{{A}_{0} + {A}_{1} \cdot X + {A}_{2} {X}^{2} + … + {A}_{n} {X}^{n}}{1 + {B}_{1} X + {B}_{2} {X}^{2} + … + {B}_{n} {X}^{n}}$$

where X is the number of iterations and A₀, A₁, A₂, . . . , Aₙ, B₀, B₁, B₂, . . . , Bₙ are constants to be evaluated to fit the data. As the number of iterations becomes large the cost tends to the asymptote to a value equal to the ration of the highest term coefficients, Aₙ/Bₙ. Thus, in order to determine the asymptote, the constants A₀, A₁, A₂, . . . , Aₙ, B₀, B₁, B₂, . . . , Bₙ of the polynomials must be computed which can for example be done using a method of least squares. In an example, a best cost to date reaches within 5% of an optimum cost (asymptote) after between 300 and 500 iterations.

In the second approach, the distribution of a fitness function or a performance parameter such as cost is approximated and the value of the fitness function or performance parameter of the best candidate solution to date is compared to the distribution to determine the likelihood that the best candidate solution to date is the optimum solution.

For example, the performance parameter may be cost. The distribution of the cost of all possible routing solutions is approximated based on two assumptions: 1) that the distribution is a normal distribution and 2) that the mean and standard deviation of the initial set of candidate solutions is representative of the mean and standard deviation of all possible candidate solutions. Assumption 2 is justified because the set of initial candidate solutions is generated randomly. Thus, the distribution of the cost of routing solutions is approximated as a normal distribution having a mean and standard deviation the same as the mean and standard deviation of the costs of the initial candidate solutions. The probability that, after any particular number of iterations, the gene pool contains the optimum solution is calculated by iterating the distribution between −∞ and the value of the cost of the best solution to date:

P(we have optimum)=∫_{-∞}^{best to date} distribution

Thus, the stopping condition is satisfied when the likelihood of the gene pool containing the optimum routing solution reaches a predetermined percentage, such as 95%.

However, it will be appreciated that a result of 95% based on a small sample size (e.g. a small number of initial candidate solutions) and/or a small number of iterations is likely to be less reliable that a result of 95% based on a large sample size and a large number of iterations. Therefore, a safeguard may be put in place by way of a minimum probability that the optimum solution has not yet been found (where P(optimum not yet found)=1−P(we have optimum)). The minimum probability may comprise a function of the size of the genepool, the number of iterations that have taken place, the standard deviation of the current genepool (which decreases as the genepool evolves), or any combination of the above. For example, the minimum probability that the optimum solution has not yet been found could be defined as:

$${P ( optimum not yet found )}_{min} = \frac{1}{\sqrt{genepool size + number of iterations}}$$

According to this definition of the minimum probability, once the minimum has been reached, further iterations will increase the likelihood that the gene pool contains the optimum but this will happen much more slowly than on previous iterations. This ensures that for a sufficiently small gene pool size, a higher number of iterations may be required before the stopping condition can reached.

Regardless of how the stopping condition is defined, once it is reached the best solution in the gene pool is selected 508 and outputted as the optimised solution.

In a further embodiment of the invention, the objective function logic and optionally the evolution logic may be implemented as a photonic quantum processor. The further embodiment provides a photonic quantum processor 602 or 702 for processing a subset of network orchestration computations to support management of network functions within a service chain spanning multiple domains of a data transport network, the device comprising: receiving logic arranged to receive computation inputs expressed in terms of a data model for describing the data transport network; processing logic arranged to process the computation inputs; and outputting logic arranged to output an output of the processing logic, the output expressed in terms of the data model.

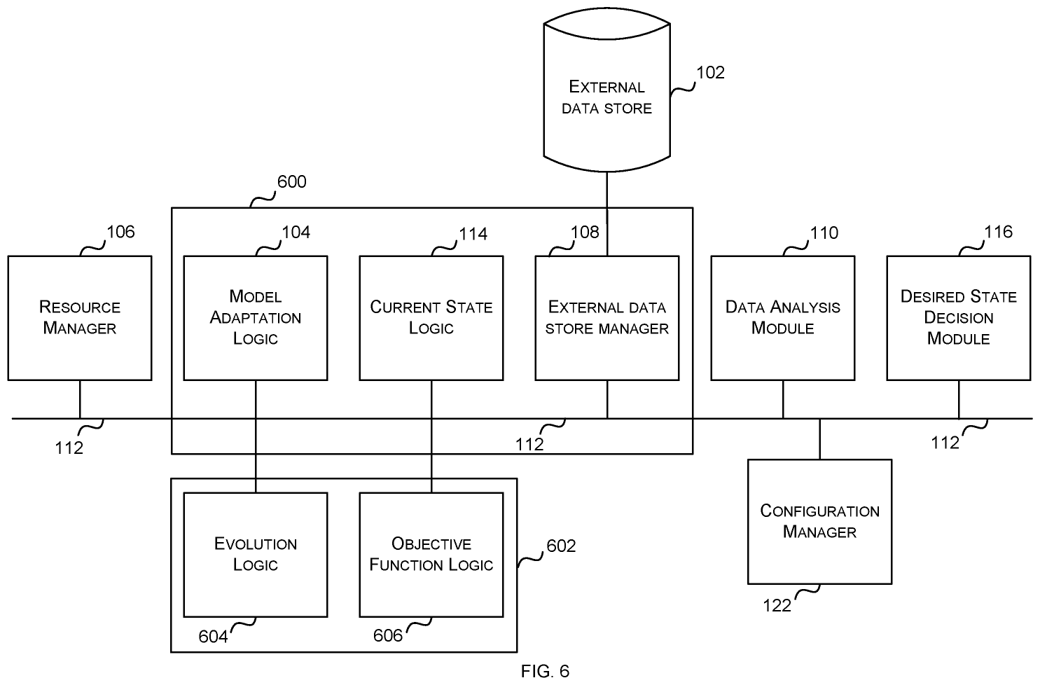

Referring to FIG. 6, the embodiment may be implemented as a photonic quantum processor 602 comprising evolution logic 604 arranged to evolve candidate solutions expressed in terms of the data model towards an optimum solution using a genetic algorithm and to determine an optimised output solution expressed in terms of the data model, and objective function logic 606 arranged to support the use of the genetic algorithm by computing a value of a fitness function of each of the candidate solutions, for example in the way described above. In this case, the photonic quantum processor 602 may be used together with a device 600 that is similar to the device 100 described above but which lacks evolution logic and objective function logic. Alternatively, the photonic quantum processor 602 may be used together with the device 100, and a separate function such as a process manager may provide instructions as to whether to use the photonic quantum processor 602 or the device 100 for evolving candidate solutions and evaluating fitness functions.

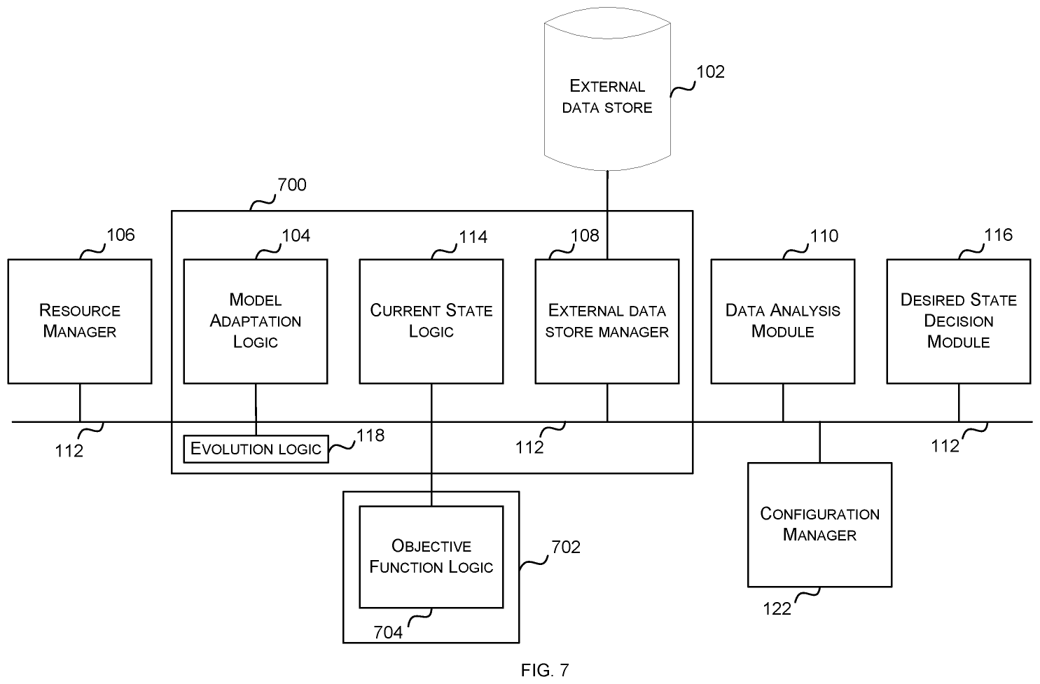

Referring to FIG. 7, the embodiment may alternatively be implemented as photonic quantum processor 702 comprising objective function logic 704 arranged to support the use of the genetic algorithm by computing a value of a fitness function of each of the candidate solutions, but no evolution logic. In this case, the photonic quantum processor 602 may be used together with a device 600 that is similar to the device 100 described above but which lacks objective function logic. Alternatively, the photonic quantum processor 602 may be used together with the device 100, and a separate function such as a process manager may provide instructions as to whether to use the photonic quantum processor 602 or the device 100 for evaluating fitness functions.

Throughout the description, the term logic refers to a structure that performs a function or functions. An example of logic includes circuitry that is arranged to perform those function(s).

For example, in the device 100 such circuitry is classical computing circuitry and may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement.

In the photonic quantum computers 602 and 702, logic may include photonic quantum processing circuitry that is arranged to perform one or more functions.

In both the device 100 and the photonic quantum computers 602 and 702, logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

1.-27. (canceled)

28. A device for processing a subset of network orchestration computations to support management of network functions within a service chain spanning multiple domains of a data transport network, the device comprising: receiving logic arranged to receive computation inputs expressed in terms of a data model for describing the data transport network; processing logic arranged to process the computation inputs; and outputting logic arranged to output an output of the processing logic, the output expressed in terms of the data model.

29. The device according to claim 28, wherein at least one of the receiving logic and the outputting logic is arranged to exchange data expressed in terms of the data model with an external data store that stores a shared description of the data transport network expressed in terms of the data model.

30. The device according to claim 29, wherein at least part of the processing logic comprises model adaptation logic arranged to: convert an input description of a state of at least part of the data transport network into an abstracted description of the state of at least part of the data transport network expressed in terms of the data model.

31. The device according to claim 30, wherein the model adaptation logic is arranged to: output the abstracted description to the external data store to update the shared description stored at the external data store.

32. The device according to claim 30, wherein at least part of the processing logic comprises current state logic arranged to: determine whether a network update is pending; and cause a copy of at least part of the shared description to be output by the outputting logic either immediately if there is no network update pending or after a pending network update is completed if there is a network update pending.

33. The device according to claim 32, wherein the current state logic determines whether a network update is pending by monitoring signals from the model adaptation logic.

34. The device according to claim 32, wherein the current state logic is arranged to: determine whether a data analysis update is pending; and cause a copy of at least part of the shared description to be output by the outputting logic either immediately if there is no data analysis update pending or after a pending data analysis update is completed if there is a data analysis update pending.

35. The device according to claim 34, wherein the current state logic determines whether a data analysis update is pending by monitoring signals from an external data analysis module.

36. The device according to claim 28, wherein at least part of the processing logic comprises evolution logic arranged to: evolve candidate solutions expressed in terms of the data model towards an optimum solution using a genetic algorithm and to determine an optimised output solution expressed in terms of the data model.

37. The device according to claim 36, wherein at least part of the processing logic comprises objective function logic arranged to: support the use of the genetic algorithm by causing computation of a value of a fitness function of each of the candidate solutions.

38. The device according to claim 37, wherein causing computation of a value of a fitness function of each of the candidate solutions comprises one or more of:
the objective function logic computing the values of the fitness function;
causing external software to compute the values of the fitness function;
causing a photonic quantum processor to compute the values of the fitness function; and
as default behaviour, the objective function logic computing the values of the fitness function, but, if instructed, the objective function logic causing external software or a photonic quantum processor to compute the values of the fitness function.

39. The device according to claim 28, wherein
the device comprises a processor; or
the receiving logic, the processing logic and the outputting logic comprises hardware logic; or
the device is implemented as at least one semiconductor chip; or
the data transport network comprises a telecommunications network.

40. Code that when executed on a processor of a system causes the system to generate in hardware a device according to claim 28.

41. A photonic quantum processor for processing a subset of network orchestration computations to support management of network functions within a service chain spanning multiple domains of a data transport network, the device comprising: receiving logic arranged to receive computation inputs expressed in terms of a data model for describing the data transport network; processing logic arranged to process the computation inputs; and outputting logic arranged to output an output of the processing logic, the output expressed in terms of the data model.

42. The photonic quantum processor according to claim 38, wherein at least part of the processing logic comprises evolution logic arranged to: evolve candidate solutions expressed in terms of the data model towards an optimum solution using a genetic algorithm and to determine an optimised output solution expressed in terms of the data model.

43. The photonic quantum processor according to claim 39, wherein at least part of the processing logic comprises objective function logic arranged to: support the use of the genetic algorithm by computing a value of a fitness function of each of the candidate solutions.

44. The photonic quantum processor according to claim 38, wherein at least part of the processing logic comprises objective function logic arranged to: support the use of a genetic algorithm for evolving candidate solutions expressed in terms of the data model by computing a value of a fitness function of each of the candidate solutions.

45. The photonic quantum processor according to claim 38, wherein the data transport network comprises a telecommunications network.

46. A system for processing a subset of network orchestration computations to support coordination of network functions across a data transport network, the system comprising: a device according to claim 28; and a photonic quantum processor for performing one or more predetermined processing tasks.

47. The system according to claim 46, wherein the one or more predetermined processing tasks comprises:
evolving candidate solutions expressed in terms of the data model towards an optimum solution using a genetic algorithm and to determining an output solution expressed in terms of the data model; and additionally or alternatively
computing a value of a fitness function of each of the candidate solutions.
